(19) United States
(12) Patent Application Publication
(10) Pub. No.: US 2026/0157455 A1
(43) Pub. Date: Jun. 11, 2026

(54) SUPPORT FRAME OF FACE SHIELD, FACE SHIELD, AND HEAD-MOUNTED DEVICE

(71) Applicant: Beijing Zitiao Network Technology Co., Ltd., Beijing (CN)

(72) Inventor: Zishang WANG, Beijing (CN)

(21) Appl. No.: 18/724,060

(22) PCT Filed: Mar. 29, 2023
(86) PCT No.: PCT/CN2023/084557

§ 371 Date: Jun. 25, 2024

(30) Foreign Application Priority Data
Apr. 15, 2022 (CN) 202210399780.6

(51) Int. Cl. A41D 13/11; A41D 27/12

(52) U.S. Cl. CPC A41D 13/1161; A41D 27/12

(57) ABSTRACT

Disclosed are a support frame (10) of a face shield (100), the face shield (100), and a head-mounted device. The support frame (10) includes: a first support (11); and a second support (12), where the second support (12) is arranged on one side of the first support (11), a middle portion of the second support (12) in a first direction is provided with a first connecting portion (123), the first connecting portion (123) is connected with the first support (11), a middle portion of the first support (11) in the first direction has a nose pad portion (113), the second support (12) is connected with two ends of the nose pad portion (113), and a portion, located between the first connecting portion (123) and the nose pad portion (113), of the second support (12) is arranged to space apart from the first support (11).

### CROSS-REFERENCE TO RELATED APPLICATION(S)

This application claims the priority of Chinese Patent Application No. 2022103997806, filed on Apr. 15, 2022, which is incorporated by reference in its entirety.

### FIELD

This application relates to the technical field of head-mounted devices, and in particular to a support frame of a face shield, the face shield, and a head-mounted device.

### BACKGROUND

In the prior art, a face-fitting face shield includes a plastic support frame and a thin sponge fitting against the plastic support frame, which has poor three-dimensional sense and poor supporting effect, resulting in poor use experience of a user.

### SUMMARY

This application aims to at least solve one of the technical problems existing in the prior art. Therefore, one objective of this application is to provide a support frame of a face shield. The support frame of the face shield can enhance use experience.

This application further provides a face shield with the above support frame.

This application further provides a head-mounted device with the above face shield.

According to a support frame of a face shield in an embodiment of a first aspect of this application, the support frame extends in a first direction and a second direction which are mutually orthogonal. The support frame includes: a first support; and a second support, where the second support is arranged on one side of the first support, a middle portion of the second support in the first direction is provided with a first connecting portion, the first connecting portion is connected with the first support, a middle portion of the first support in the first direction has a nose pad portion extending towards a direction away from the second support, the second support is connected with two ends of the nose pad portion, and a portion, located between the first connecting portion and the nose pad portion, of the second support is arranged to space apart from the first support.

According to the support frame of the face shield in this embodiment of this application, by arranging the support frame into the above structure, the weight can be reduced. Because the second support is of a cantilever structure that is fixed to the first support in the middle and spaced apart from the first support at the two ends, the two ends of the second support in the first direction may move relative to the first support, and the second support deforms under the action of the face, thereby buffering the feeling of oppression on the face. The second support may fit against the face under reaction force, thereby ensuring a wearing effect and then enhancing the sense of use of the face shield.

According to some embodiments of this application, a distance between the second support and the first support increases in the first direction away from the nose pad portion and/or the first connecting portion.

According to some embodiments of this application, the first support forms a closed annular structure, and a portion, connected with the first connecting portion, of the first support is arranged to space apart from the nose pad portion in the second direction.

According to some embodiments of this application, the two ends of the nose pad portion in the first direction are provided with second connecting portions respectively, the second support is provided with two second fitting portions, and the two second connecting portions and the two second fitting portions are connected through one-to-one correspondence.

In some embodiments, the second fitting portion forms a second fitting protrusion rib protruding from an outer surface of the second support.

In some embodiments, the second support includes: a first inner arc segment, where one end of the first inner arc segment is connected with one end of the nose pad portion, and the other end of the first inner arc segment is connected with one end of the first connecting portion; and a second inner arc segment, where one end of the second inner arc segment is connected with the other end of the nose pad portion, and the other end of the second inner arc segment is connected with the other end of the first connecting portion.

In some embodiments, the middle portion of the first support in the first direction is provided with a third connecting portion, one side of the first connecting portion towards the first support is provided with at least one third fitting portion, and the third fitting portion is connected with the third connecting portion.

In some examples, the third fitting portion forms a third fitting protrusion rib protruding from an outer surface of the first connecting portion.

In some examples, the first support includes: a first outer arc segment, where one end of the first outer arc segment is connected with one end of the nose pad portion, and the other end of the first outer arc segment is connected with one end of the third connecting portion; and a second outer arc segment, where one end of the second outer arc segment is connected with the other end of the nose pad portion, and the other end of the second outer arc segment is connected with the other end of the third connecting portion.

According to some embodiments of this application, the first support and the second support are separately formed.

In some embodiments, the first support and the second support are connected through a bonding manner, a welding manner, fasteners, or a snap-fit structure.

According to some other embodiments of this application, the first support and the second support are integrally formed.

A face shield according to an embodiment of a second aspect of this application includes an elastic pad; and the support frame of the face shield according to the above embodiment, where the support frame is provided with a fitting surface fitting against the face, and the elastic pad at least covers the fitting surface.

According to the face shield in this embodiment of this application, by arranging the elastic pad on the fitting surface, a buffering effect may be achieved, and elastic support may also be provided. By adopting the above support frame, the weight of the face shield can be reduced, and the feeling of oppression on the face by the elastic pad may also be alleviated.

In some embodiments, the elastic pad includes one or more of sponge, rubber, and latex.

In some embodiments, the face shield further includes a coating layer, and the coating layer at least covers a portion of the elastic pad corresponding to the fitting surface.

In some examples, the coating layer is of an integrated structure, or there are a plurality of coating layers which are spliced together.

A head-mounted device according to an embodiment of a third aspect of this application includes the face shield according to the above embodiment.

The head-mounted device according to this embodiment of this application has a relatively small weight and less feeling of oppression on the face, which is conducive to improving use experience of a user.

Additional aspects and advantages of this application will be partially given in the following description, and partially will become apparent from the following description, or may be learned from practices of this application.

### BRIEF DESCRIPTION OF THE DRAWINGS

The foregoing and/or additional aspects and advantages of this application will become apparent and comprehensible in the description of the embodiments made with reference to the following accompanying drawings.

FIG. 1 is a structural schematic diagram of a support frame of a face shield according to an embodiment of this application;

FIG. 2 is an enlarged view of a portion A shown in FIG. 1;

FIG. 3 is an enlarged view of a portion B shown in FIG. 1; and

FIG. 4 is a structure exploded view of a face shield according to an embodiment of this application.

### REFERENCE NUMERALS

face shield 100,
support frame 10, fitting surface 101, first support 11, second connecting portion 111, third connecting portion 112, nose pad portion 113, first outer arc segment 1141, second outer arc segment 1142, second support 12, second fitting portion 121, third fitting portion 122, first connecting portion 123, first inner arc segment 1241, second inner arc segment 1242,
elastic pad 20, and coating layer 30.

### DETAILED DESCRIPTION OF EMBODIMENTS

Embodiments of this application are described in detail below, and examples of the embodiments are shown in the accompanying drawings, and the same or similar numerals denote the same or similar elements or elements having the same or similar functions throughout the description. The embodiments described below with reference to the accompanying drawings are exemplary, are used only for explaining this application, and should not be construed as a limitation on this application.

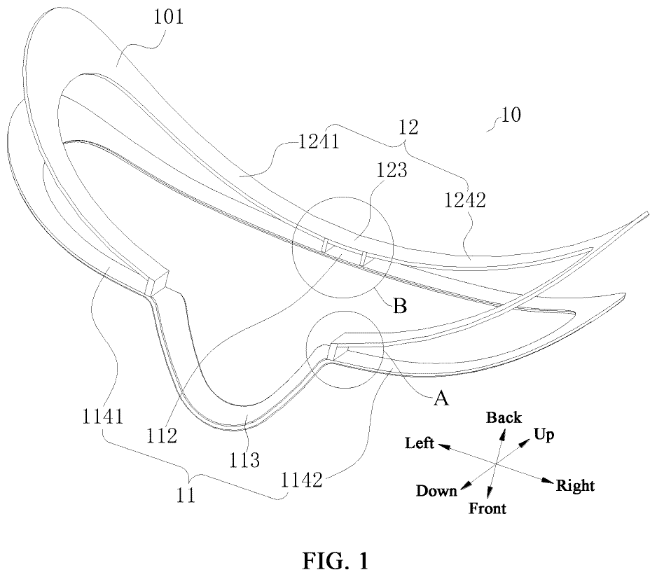

The following describes a support frame 10 of a face shield according to embodiments of this application with reference to FIG. 1 to FIG. 3. The support frame 10 extends in a first direction (a left-right direction shown in FIG. 1) and a second direction (an up-down direction shown in FIG. 1) that are orthogonal to each other.

In the description of this application, it should be understood that orientation or position relationships indicated by the terms such as “center”, “upper”, “lower”, “front”, “back”, “left”, “right”, “inside”, and “outside” are based on orientation or position relationships shown in the accompanying drawings, and are intended to facilitate the description of this application and simplify the description only, rather than indicate or imply that the referred apparatus or element must have a particular orientation or must be constructed and operated in a particular orientation. Therefore, such terms should not be construed as a limitation to this application.

As shown in FIG. 1, the support frame 10 of the face shield according to this embodiment of this application includes a first support 11 and a second support 12. The second support 12 is arranged on one side of the first support 11 (a rear side of the first support 11 shown in FIG. 1). A middle portion of the second support 12 in the first direction is provided with a first connecting portion 123, and the first connecting portion 123 is connected with the first support 11.

A middle portion of the first support 11 in the first direction has a nose pad portion 113. The nose pad portion 113 extends towards a direction away from the second support 12, and forms a nose imitating structure, such that the nose pad portion 113 can be adapted to the nose. The nose pad portion 113 and the first connecting portion 123 are spaced in the second direction. Two ends of the nose pad portion 113 are connected with the second support 12. A portion, located between the first connecting portion 123 and the nose pad portion 113, of the second support 12 is arranged to space apart from the first support 11.

In other words, relative to the first support 11, the second support 12 forms a cantilever structure that is fixed to the first support 11 in the middle and spaced apart from the first support 11 at two ends, allowing the two ends of the second support12 in the first direction to move relative to the first support 11 under the action of force.

During use, the nose pad section 113 fits against the nose, providing support through the nose. The second support 12 fits against the face. The second support 12 deforms under the pressure of the face so as to buffer the feeling of oppression on the face, and the second support 12 fit against the face under reaction force, thereby ensuring a wearing effect.

According to the support frame 10 of the face shield in this embodiment of this application, by arranging the support frame 10 into the above structure, the weight can be reduced. Because the second support 12 is of the cantilever structure that is fixed to the first support 11 in the middle and spaced apart from the first support 11 at the two ends, the two ends of the second support 12 in the first direction may move relative to the first support 11, and the second support 12 deforms under the action of the face, thereby buffering the feeling of oppression on the face. The second support 12 may fit against the face under the reaction force, thereby ensuring the wearing effect and then enhancing the sense of use of the face shield.

As shown in FIG. 1, according to some embodiments of this application, a distance between the second support 12 and the first support 11 increases in the first direction away from the nose pad portion113 and/or the first connecting portion 123, enhancing the three-dimensional feel of the support frame 10, such that the second support 12 can form a structure fitting against the face, and the first support 11 can be matched with other structures of a head-mounted device.

According to some embodiments of this application, the first support 11 forms a closed annular structure, and a portion, connected with the first connecting portion 123, of the first support 11 is arranged to space apart from the nose pad portion 113 in the second direction.

In other words, the first support 11 is provided with the nose pad portion 113 and a first connecting structure (e.g., a third connecting portion 112 described below) which are spaced in the second direction, and the second support 13 is arranged on the rear side of the first support 11 and may form an open annular structure. The second support 12 is provided with a second connecting structure (e.g., two second fitting portions 121 described below) and the first connecting portion 123 which are spaced in the second direction. The second connecting structure is connected with the two ends of the nose pad portion 113 in the first direction. The first connecting structure is connected with the first connecting portion 123, such that the second support 12 forms the cantilever structure that is fixed to the first support 11 in the middle and spaced apart from the first support 11 at the two ends. The structure is simple and has stronger three-dimensional sense, which is conducive to supporting.

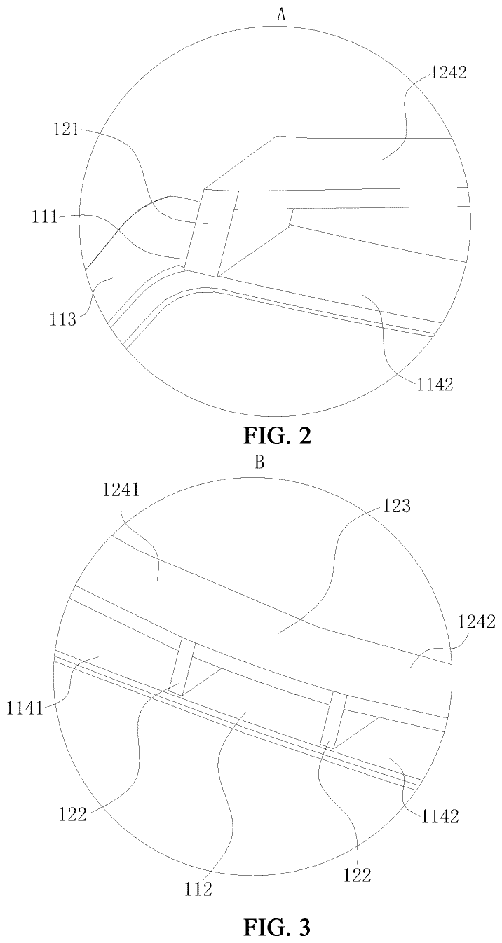

As shown in FIG. 1 and FIG. 2, according to some embodiments of this application, the two ends of the nose pad portion 113 are provided with second connecting portions 111 respectively. The second support 12 is provided with the two fitting portions 121. The two second connecting portions 111 and the two second fitting portions 121 are connected through one-to-one correspondence, thereby connecting the first support 11 and the second support 12.

For example, the first support 11 and the second support 12 may be connected in a welding manner, that is, the second connecting portions 111 and the second fitting portions 121 may respectively form welding portions. For another example, the first support 11 and the second support 12 may be connected through fasteners, and connection holes may be formed in the second connecting portions 111 and the second fitting portions 121, thereby achieving connection through the fasteners penetrating through the connection holes. For yet another example, the first support 11 and the second support 12 may be connected through a snap-fit structure, one of the second connecting portion 111 and the second fitting portion 121 may form a snap, and the other end may form a snap groove that matches the snap.

As shown in FIG. 2, in some embodiments, the second fitting portion 121 forms a second fitting protrusion rib, and the second fitting protrusion rib protrudes out of an outer surface of the second support 12. The structure is simple, and forming is convenient.

Specifically, as shown in FIG. 1 and FIG. 2, the first direction of the support frame 10 extends in the left-right direction, and the second direction of the support frame 10 extends in the up-down direction. The second support 12 is arranged on the rear side of the first support 11, that is, a front side of the second support 12 is opposite to the rear side of the first support 11, and a rear side of the second support 12 forms the side abutting against the face.

Further, a left end and a right end of the nose pad portion 113 are provided with the second connecting portions 111 respectively, and the middle portion of the second support 12 is provided with the two second fitting portions 121 which are spaced in the left-right direction. The left end of the nose pad portion 113 and the second fitting portion 121 of the second support 12 located on the left side are connected through the second connecting portion 111, and the right end of the nose pad portion 113 and the second fitting portion 121 of the second support 12 located on the right side are connected through the second connecting portion 111.

A position, corresponding to the nose pad portion 113, of the second support 12 is provided with a relief notch, and the two second fitting portions 121 are located on two sides of the relief notch.

In some embodiments, the second support 12 includes a first inner arc segment 1241, and the first inner arc segment 1241 is suitable for fitting against the left cheek of the face. One end of the first inner arc segment 1241 is connected with one end of the nose pad portion 113, and the other end of the first inner arc segment 1241 is connected with one end of the first connecting portion 123. That is, the two ends of the first inner arc segment 1241 are connected with the first support 11 to form a fixed end, and other portions of the first inner arc segment 1241 are spaced apart from the first support 11, thereby allowing the first inner arc segment 1241 to deform under external force.

Further, the second support 12 also includes a second inner arc segment 1242, and the second inner arc segment 1242 is suitable for fitting against the right cheek of the face. One end of the second inner arc segment 1242 is connected with the other end of the nose pad portion 113, and the other end of the second inner arc segment 1242 is connected with the other end of the first connecting portion 123. That is, the two ends of the second inner arc segment 1242 are connected with the first support 11 to form a fixed end, and other portions of the second inner arc segment 1242 are spaced apart from the first support 11, thereby allowing the second inner arc segment 1242 to deform under external force.

Therefore, the second support 12 abuts against the face, and the first inner arc segment 1241 and the second inner arc segment 1242 deform under the pressure of the face, thereby buffering the feeling of oppression on the face. The first inner arc segment 1241 and the second inner arc segment 1242 may respectively fit against the left cheek and the right cheek of the face under the reaction force, thereby ensuring the wearing effect and then enhancing the sense of use of the face shield.

As shown in FIG. 1 and FIG. 3, in some embodiments, the middle portion of the first support 11 in the first direction is provided with the third connecting portion 112, the third connecting portion 112 and the nose pad portion 113 are spaced in the second direction, and the third connecting portion 112 is connected with the first connecting portion 123. The side, towards the first support 11, of the first connecting portion 123 is provided with one or more third fitting portions 122. The third fitting portions 122 are connected with the third connecting portion 112 so as to connect the first support 11 and the second support 12.

For example, the first support 11 and the first connecting portion 123 of the second support 12 may be connected in a welding manner, that is, the third fitting portions 122 and the third connecting portion 112 may respectively form welding portions. For another example, the first support 11 and the first connecting portion 123 of the second support 12 may be connected through fasteners, and connection holes may be formed in the third fitting portions 122 and the third connecting portion 112, thereby achieving connection through the fasteners penetrating through the connection holes. For yet another example, the first support 11 and the first connecting portion 123 of the second support 12 may be connected through a snap-fit structure, one of the third fitting portion 122 and the third connecting portion 112 may form a snap, and the other end may form a snap groove that matches the snap.

As shown in FIG. 3, in some specific examples, the third fitting portion 122 forms a third fitting protrusion rib protruding from an outer surface of the first connecting portion 123. The structure is simple, and forming is convenient.

Specifically, as shown in FIG. 1 and FIG. 3, the first direction of the support frame 10 extends in the left-right direction, and the second direction of the support frame 10 extends in the up-down direction. The second support 12 is arranged on the rear side of the first support 11, that is, a front side of the second support 12 is opposite to the rear side of the first support 11, and a rear side of the second support 12 forms the side abutting against the face.

Further, the third connecting portion 112 and the first connecting portion 123 are opposite in the front-back direction, one side of the first connecting portion 123 towards the first support 11 is provided with two third fitting portions 122, and the two third fitting portions 122 are spaced in the left-right direction and are both connected with the third connecting portion 112, thereby connecting the third connecting portion 112 and the first connecting portion 123.

In some examples, a distance between the two third fitting portions 122 on the second support 12 in the first direction is less than a distance between the two ends of the nose pad portion 113 in the first direction.

In some examples, the first support 11 includes a first outer arc segment 1141, one end of the first outer arc segment 1141 is connected with one end of the nose pad portion 113, and the other end of the first outer arc segment 1141 is connected with one end of the third connecting portion 112. That is, the two ends of the first outer arc segment 1141 are connected with the second support 12, and a distance between the first outer arc segment 1141 and the first inner arc segment 1241 may change under the action of external force.

Further, the first support 11 further includes a second outer arc segment 1142, one end of the second outer arc segment 1142 is connected with the other end of the nose pad portion 113, and the other end of the second outer arc segment 1142 is connected with the other end of the third connecting portion 112. That is, the two ends of the second outer arc segment 1142 are connected with the second support 12, and a distance between the second outer arc segment 1142 and the second inner arc segment 1242 may change under the action of external force.

Therefore, the second support 12 abutts against the face, and the first inner arc segment 1241 may deform relative to the first outer arc segment 1141 under the pressure of the face, and the second inner arc segment 1242 may deform relative to the second outer arc segment 1142 under the pressure of the face, thereby buffering the feeling of oppression on the face. The first inner arc segment 1241 and the second inner arc segment 1242 may fit against the face through the reaction force, thereby ensuring the wearing effect and then enhancing the sense of use of the face shield.

According to some embodiments of this application, the first support 11 and the second support 12 are separately formed, and are simple in structure, convenient to form, and easy to implement.

In some embodiments, the first support 11 and the second support 12 are connected through a bonding manner, a welding manner, fasteners, or a snap-fit structure, which may be specifically selected according to materials of the first support 11 and the second support 12 and other situations.

Specifically, in the example that the first support 11 includes the second connecting portion 111 and the second support 12 includes the first connecting portion 123, the second connecting portion 111 and the first connecting portion 123 may be welded together, or may be fixed through at least one fastener, or may be connected together through a manner of cooperation of a snap and a snap groove.

In the example that the first support 11 includes the nose pad portion 113 and the second support 12 includes the two second fitting portions 121, the two ends of the nose pad portion 113 in the first direction and the two second fitting portions 121 may be welded together in a one-to-one correspondence manner, or may be fixed together through fasteners, or may be connected together through a snap-fit structure.

According to some other embodiments of this application, the first support 11 and the second support 12 are integrally formed. For example, the first support 11 and the second support 12 may integrally formed through an injection molding process. By integrally forming the first support 11 and the second support 12, the number of components can be reduced, and connecting elements and connecting processes between them are omitted, thereby improving structural strength of the support frame 10.

The following describes a face shield 100 according to an embodiment of this application with reference to FIG. 1 to FIG. 4.

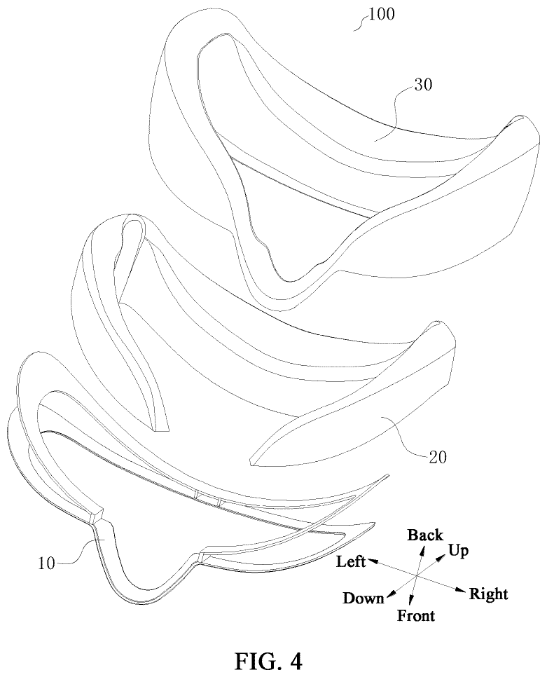

As shown in FIG. 4, the face shield 100 according to this embodiment of this application includes an elastic pad 20 and the support frame 10 of the face shield according to the above embodiment. The support frame 10 is provided with a fitting surface 101 which may abut against the face. The elastic pad 20 at least covers the fitting surface 101.

According to the face shield 100 in this embodiment of this application, by arranging the elastic pad 20 on the fitting surface 101, a buffering effect may be achieved, and elastic support may also be provided. By adopting the above support frame 10, the weight of the face shield 10 can be reduced, and the feeling of oppression on the face by the elastic pad 20 may also be alleviated.

In some embodiments, the elastic pad 20 includes one or more of sponge, rubber, and latex, and is simple in structure and low in cost. The material of the elastic pad 20 may be specifically selected according to actual situations. The elastic pad 20 may be attached to the fitting surface 101 in a bonding manner.

As shown in FIG. 4, in some embodiments, the face shield 100 further includes a coating layer 30, and the coating layer 30 at least covers a portion of the elastic pad 20 corresponding to the fitting surface 101. Therefore, by arranging the coating layer 30 on an outer side of the elastic pad 20, integrity is better, it is beneficial to improving the appearance, and detaching and washing are convenient.

A material of the coating layer 30 may be ordinary cloth or polyurethane (PU), thermoplastic polyurethane elastomer rubber (TPU), etc.

For example, the elastic pad 20 may only cover the fitting surface 101, and the coating layer 30 only covers one side of the elastic pad 20 away from the fitting surface 101, such that the face shield 100 forms a three-layer structure with the elastic pad 20 in the middle and the support frame 10 and the coating layer 30 on two sides respectively. For another example, the coating layer 30 may integrally cover the elastic pad 20 with the support frame 10. For yet another example, the elastic pad 20 may integrally cover an outer portion of the support frame 10, and the coating layer 30 may integrally wrap the support frame 10 with the elastic pad 20.

In some examples, the coating layer 30 is of an integrated structure, and is simple in structure, smooth in appearance, and better in integrity. Specifically, two sides of the coating layer 30 may be connected together in manners such as stitching and bonding, so as to wrap the support frame 10 with the elastic pad 20.

In some other examples, there are a plurality of coating layers 30 and are spliced together. The plurality of coating layers 30 may be first connected together in manners such as stitching and bonding and then are connected together in manners such as stitching and bonding, so as to wrap the support frame 10 with the elastic pad 20, thereby satisfying different appearance requirements.

The head-mounted device in this embodiment of this application includes the face shield 100 according to the above embodiment. Because the face shield 100 according to this embodiment of this application has the above technical effects, the head-mounted device in this embodiment of this application also has the above technical effects. That is, the head-mounted device of this application has a relatively small weight and less feeling of oppression on the face, which is conducive to improving use experience of a user.

Other components and operations of the face shield 100 and the head-mounted device according to this embodiment of this application are known to those of ordinary skill in the art, which are not described in detail here.

In the descriptions of this specification, descriptions using reference terms “an embodiment”, “some embodiments”, “an exemplary embodiment”, “an example”, “a specific example”, or “some examples” mean that specific features, structures, materials, or characteristics described with reference to the embodiment or example are included in at least one embodiment or example of this application. In this specification, exemplary descriptions of the foregoing terms do not necessarily refer to the same embodiment or example. In addition, the described specific features, structures, materials, or characteristics may be combined in a proper manner in any one or more of the embodiments or examples.

Although the embodiments of this application have been shown and described, those of ordinary skill in the art can understand that these embodiments can be variously changed, modified, replaced, and transformed without departing from the principle and the purpose of this application, and the scope of this application is limited by the claims and equivalents thereof.

1. A support frame of a face shield, wherein the support frame extends in a first direction and a second direction which are mutually orthogonal, and the support frame comprises:
a first support; and
a second support, wherein the second support is arranged on one side of the first support, a middle portion of the second support in the first direction is provided with a first connecting portion, the first connecting portion is connected with the first support,
wherein a middle portion of the first support in the first direction has a nose pad portion extending towards a direction away from the second support, the second support is connected with two ends of the nose pad portion, and a portion of the second support between the first connecting portion and the nose pad portion is arranged to space apart from the first support.

2. The support frame of the face shield according to claim 1, wherein a distance between the second support and the first support increases along the first direction away from the nose pad portion and/or the first connecting portion.

3. The support frame of the face shield according to claim 1, wherein the first support forms a closed annular structure, and a portion of the first support connected with the first connecting portion is arranged to space apart from the nose pad portion in the second direction.

4. The support frame of the face shield according to claim 1, wherein two ends of the nose pad portion in the first direction are provided with second connecting portions respectively, the second support is provided with two second fitting portions, and the two second connecting portions and the two second fitting portions are connected through one-to-one correspondence.

5. The support frame of the face shield according to claim 4, wherein the second fitting portion forms a second fitting protrusion rib protruding from an outer surface of the second support.

6. The support frame of the face shield according to claim 4, wherein the second support comprises:
a first inner arc segment, wherein one end of the first inner arc segment is connected with one end of the nose pad portion, and the other end of the first inner arc segment is connected with one end of the first connecting portion; and
a second inner arc segment, wherein one end of the second inner arc segment is connected with the other end of the nose pad portion, and the other end of the second inner arc segment is connected with the other end of the first connecting portion.

7. The support frame of the face shield according to claim 1, wherein the middle portion of the first support in the first direction is provided with a third connecting portion, one side of the first connecting portion towards the first support is provided with at least one third fitting portion, and the third fitting portion is connected with the third connecting portion.

8. The support frame of the face shield according to claim 7, wherein the third fitting portion forms a third fitting protrusion rib protruding from an outer surface of the first connecting portion.

9. The support frame of the face shield according to claim 7, wherein the first support comprises:
a first outer arc segment, wherein one end of the first outer arc segment is connected with one end of the nose pad portion, and the other end of the first outer arc segment is connected with one end of the third connecting portion; and
a second outer arc segment, wherein one end of the second outer arc segment is connected with the other end of the nose pad portion, and the other end of the second outer arc segment is connected with the other end of the third connecting portion.

10. The support frame of the face shield according to claim 1, wherein the first support and the second support are separately formed.

11. The support frame of the face shield according to claim 10, wherein the first support and the second support are connected through a bonding manner, a welding manner, fasteners, or a snap-fit structure.

12. The support frame of the face shield according to claim 1, wherein the first support and the second support are integrally formed.

13. A face shield, comprising:
an elastic pad; and
the support frame of the face shield, wherein the support frame extends in a first direction and a second direction which are mutually orthogonal, and the support frame comprises:
a first support; and
a second support, wherein the second support is arranged on one side of the first support, a middle portion of the second support in the first direction is provided with a first connecting portion, the first connecting portion is connected with the first support,
wherein a middle portion of the first support in the first direction has a nose pad portion extending towards a direction away from the second support, the second support is connected with two ends of the nose pad portion, and a portion of the second support between the first connecting portion and the nose pad portion is arranged to space apart from the first support, and
wherein the support frame has a fitting surface abutting against the face, and the elastic pad at least covers the fitting surface.

14. The face shield according to claim 13, wherein the elastic pad comprises one or more of: sponge, rubber, or latex.

15. The face shield according to claim 13, further comprising: a coating layer, wherein the coating layer at least covers a portion of the elastic pad corresponding to the fitting surface.

16. The face shield according to claim 15, wherein the coating layer has an integral structure, or there are a plurality of coating layers which are spliced together.

17. A head-mounted device, comprising the face shield, wherein the face shield comprises:
an elastic pad; and
the support frame of the face shield, wherein the support frame extends in a first direction and a second direction which are mutually orthogonal, and the support frame comprises:
a first support; and
a second support, wherein the second support is arranged on one side of the first support, a middle portion of the second support in the first direction is provided with a first connecting portion, the first connecting portion is connected with the first support,
wherein a middle portion of the first support in the first direction has a nose pad portion extending towards a direction away from the second support, the second support is connected with two ends of the nose pad portion, and a portion of the second support between the first connecting portion and the nose pad portion is arranged to space apart from the first support, and
wherein the support frame has a fitting surface abutting against the face, and the elastic pad at least covers the fitting surface.

18. The face shield according to claim 13, wherein a distance between the second support and the first support increases along the first direction away from the nose pad portion and/or the first connecting portion.

19. The face shield according to claim 13, wherein the first support forms a closed annular structure, and a portion of the first support connected with the first connecting portion is arranged to space apart from the nose pad portion in the second direction.

20. The face shield according to claim 13, wherein two ends of the nose pad portion in the first direction are provided with second connecting portions respectively, the second support is provided with two second fitting portions, and the two second connecting portions and the two second fitting portions are connected through one-to-one correspondence.
